(19) United States
(12) Patent Application Publication
(10) Pub. No.: US 2011/0156322 A1
(43) Pub. Date: Jun. 30, 2011

(54) IMPRINT MATERIAL AND PROCESSING METHOD

(76) Inventor: Hiroshi TOKUE, Kanagawa-ken (JP)

(21) Appl. No.: 12/963,724

(22) Filed: Dec. 9, 2010

(30) Foreign Application Priority Data
Dec. 24, 2009 (JP) 2009-292190

(51) Int. Cl. C08L 31/02; B29C 35/08

(52) U.S. Cl. 264/496; 524/556

(57) ABSTRACT

According to one embodiment, an imprint material includes a resin and a plurality of fine particles. The resin is cured from a liquid state by receiving energy while being in contact with a protrusion-depression pattern of a template. The plurality of fine particles are contained in a solid state in the resin and are different from the resin in volume shrinkage ratio upon receiving the energy.

### CROSS-REFERENCE TO RELATED APPLICATION

This application is based upon and claims the benefit of priority from Japanese Patent Application No. 2009-292190, filed on Dec. 24, 2009; the entire contents of which are incorporated herein by reference.

### FIELD

Embodiments described herein relate generally to an imprint material and a processing method.

### BACKGROUND

Recently, an imprint method has been proposed as a method for forming a fine pattern. In the imprint method, a template with a protrusion-depression pattern formed thereon is brought into contact with an organic material applied onto a substrate. Then, the organic material is cured by e.g. light irradiation. Thus, the pattern is transferred to the organic material.

The organic material is cured while being in contact with the sidewall of the pattern protrusion of the template. After the curing, when the template is separated from the organic material, the organic material may be deformed or broken by the frictional force from the sidewall of the pattern protrusion of the template.

### BRIEF DESCRIPTION OF THE DRAWINGS

FIG. 1 is a flow chart of a processing method according to an embodiment;

FIGS. 2A to 2C are schematic sectional views showing the process for pattern transfer into an imprint material in the processing method according to the embodiment;

FIGS. 3A to 3C are enlarged schematic cross section of the process shown in FIGS. 2A to 2C; and

FIG. 4 is a schematic view showing another example of the imprint material according to the embodiment.

### DETAILED DESCRIPTION

According to one embodiment, an imprint material includes a resin and a plurality of fine particles. The resin is cured from a liquid state by receiving energy while being in contact with a protrusion-depression pattern of a template. The plurality of fine particles are contained in a solid state in the resin and are different from the resin in volume shrinkage ratio upon receiving the energy.

Embodiments of the invention will now be described with reference to the drawings.

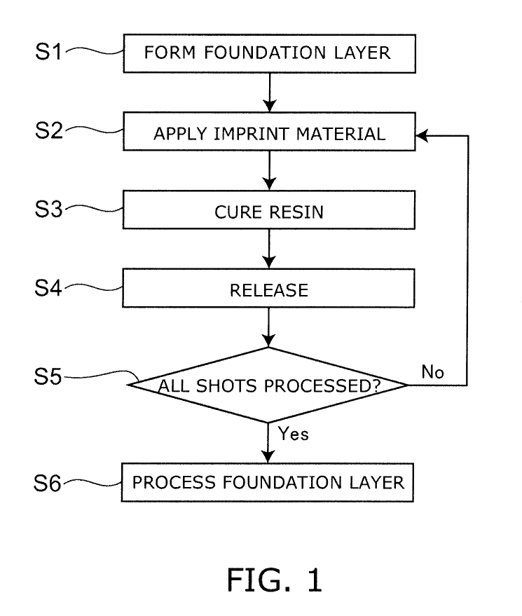

FIG. 1 shows a flow chart of a processing method according to an embodiment.

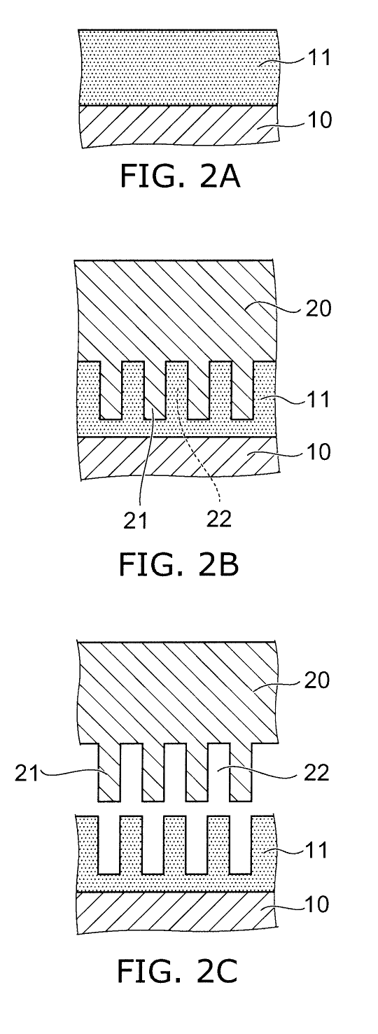

FIGS. 2A to 2C are schematic sectional views showing the process for pattern transfer into an imprint material 11 in the processing method according to this embodiment.

First, a foundation layer 10 is formed on a substrate (step S1). The foundation layer 10 is a target layer subjected to processing, such as etching, using a pattern-transferred imprint material 11 as a mask. The foundation layer 10 is illustratively an insulating layer, semiconductor layer, or conductive layer. For instance, the substrate can be a silicon substrate, and the foundation layer 10 can be a silicon oxide film.

Next, as shown in FIG. 2A, an imprint material 11 is supplied onto the foundation layer 10 (step S2). A liquid imprint material 11 is applied onto the foundation layer 10 by e.g. spin coating.

Next, as shown in FIG. 2B, a template 20 is brought into contact with the imprint material 11. On the template 20, a protrusion-depression pattern including protrusions 21 and depressions 22 is formed. The protrusion-depression pattern is pressed against the imprint material 11, and the depression 22 is filled with the imprint material 11. In that state, the imprint material 11 is irradiated with light as energy for curing. Thus, the imprint material 11 is cured (solidified) (step S3).

As described later, the imprint material 11 includes a photocurable resin, and more specifically a resin to be cured by polymerization under ultraviolet irradiation. The template 20 is made of a material transmissive to ultraviolet radiation. Hence, when the template 20 is irradiated with ultraviolet radiation from above, the ultraviolet radiation is transmitted through the template 20 to the imprint material 11. Thus, the imprint material 11 (more accurately, the resin included in the imprint material 11) is cured.

The protrusion 21 of the template 20 enters the imprint material 11 so as to wedge away the imprint material 11. With the depression 22 filled with the imprint material 11, the imprint material 11 is cured. Hence, after the curing, a pattern with protrusions and depression reversed from the protrusion-depression pattern of the template 20 is transferred to the imprint material 11.

Next, as shown in FIG. 2C, the template 20 is pulled up from the imprint material 11. Thus, the imprint material 11 is released from the template 20 (step S4). That is, the imprint material 11 is separated from the template 20.

Next, in step S5, it is determined whether the above pattern transfer process is completed for the entire target region. If it is completed, the control proceeds to the next process (step S6). Otherwise, the control returns to step S2.

In the next step S6, the imprint material 11 with the protrusion-depression pattern transferred is used as a mask to perform processing, such as etching and ion implantation, on the foundation layer 10.

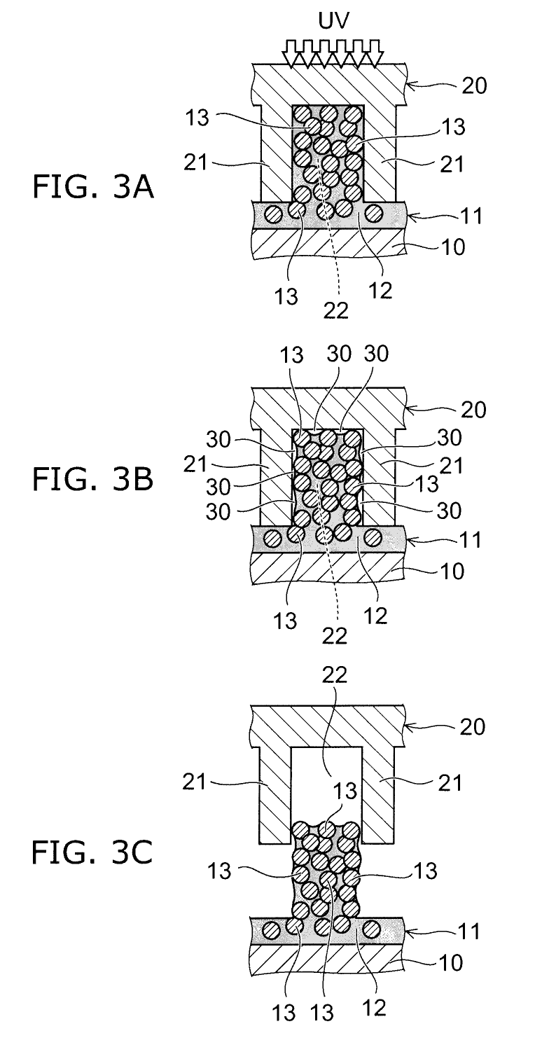

Next, the imprint material 11 is described in detail with reference to FIGS. 3A to 3C.

FIG. 3A shows an enlarged schematic cross section of the contact portion between the template 20 and the imprint material 11.

The imprint material 11 includes a resin 12 to be cured by polymerization under ultraviolet irradiation, and a plurality of fine particles 13 contained in the resin 12. The resin 12 is liquid before curing. The fine particle 13 is present in the solid state in the resin 12 before and after the curing of the resin 12.

The resin 12 is illustratively obtained by mixing an acrylate ester, an acrylate, a cross-linker, and a photoinitiator in the ratio of 50 wt %, 30 wt %, 15 wt %, and 5 wt %, respectively.

The plurality of fine particles 13 contained in the resin 12 have a mean particle diameter of e.g. 5 nm. The fine particle 13 is illustratively a polymer fine particle obtained by solidifying a monomer solution primarily composed of an organic material by polymerization. The polymerization for obtaining the polymer fine particle can be e.g. emulsion polymerization, dispersion polymerization, or suspension polymerization.

The polymer fine particles obtained by the above polymerization have a mean particle diameter of approximately 30 nm. They are passed through a ceramic filter having a pore diameter of 5 nm to obtain fine particles 13 having a mean particle diameter of 5 nm or less.

The resin 12 and the fine particles 13 are mixed in the ratio of e.g. 70 wt %:30 wt %, respectively. This mixture is sufficiently stirred. Then, as the case may be, a dispersant is further mixed therewith and dispersed by a disperser. Thus, the imprint material 11 is obtained.

The resin 12 is cured by polymerization under ultraviolet irradiation. The liquid resin 12 is cured with volume shrinkage. The volume shrinkage ratio of the resin 12 upon curing is approximately 3-5%.

In contrast, the fine particle 13 has been contained in the resin 12 as a solid polymer since before ultraviolet irradiation. Thus, its volume shrinkage ratio under the ultraviolet irradiation is lower than that of the resin 12. Hence, little volume shrinkage occurs in the fine particle 13 even under the ultraviolet irradiation.

FIG. 3B shows the state after curing. Due to the difference in volume shrinkage ratio between the resin 12 and the fine particle 13 upon curing, a fine gap 30 occurs between the sidewall of the protrusion 21 of the template 20 and the imprint material 11.

The solid fine particles 13 contained in the resin 12 can ensure contact between the imprint material 11 and the template 20 even after the resin 12 is cured and shrunk from the liquid state. That is, the gap 30 is not widely connected along the inner wall surface of the depression 22 of the template 20, but exists in the state of being divided into a plurality by the contact portion between the template 20 and the fine particle 13. This can suppress large variation in the dimension and shape of the pattern protrusion of the imprint material 11 cured in the depression 22 of the template 20.

After curing, the contact area between the sidewall of the protrusion 21 of the template 20 and a plurality of fine particles 13 is larger than the contact area between the sidewall of the protrusion 21 of the template 20 and the resin 12. Thus, the imprint material 11 is in point contact with the sidewall of the protrusion 21 of the template 20 via a plurality of fine particles 13. This reduces the frictional force between the sidewall of the pattern protrusion of the imprint material 11 and the sidewall of the protrusion 21 of the template 20 when the template 20 is relatively pulled up and released from the imprint material 11 as shown in FIG. 3C. Consequently, at the time of releasing, the stress acting on the imprint material 11 is reduced. This can suppress pattern defects of the pattern protrusion of the imprint material 11, such as deformation, breakage, fracture, and collapse.

Furthermore, the plurality of solid fine particles 13 contained in the resin 12 increase the mechanical strength of the imprint material 11. This also serves to avoid pattern defects of the imprint material 11 at the time of releasing.

That is, according to this embodiment, the volume shrinkage of the resin 12 upon curing is used to reduce adhesiveness between the template 20 and the imprint material 11 to improve releasability. Furthermore, the plurality of solid fine particles 13 contained in the resin 12 can ensure the desired dimension and shape of the pattern transferred into the imprint material 11.

To suppress the variation in the shape and dimension of the pattern of the imprint material 11 within a desired range, the size of the aforementioned gap 30 in the pattern width direction is preferably within 10% or less of the protrusion pattern width of the imprint material 11. For instance, if the width of the protrusion of the imprint material 11 is 50 nm, the total amount of shrinkage of the protrusion at both sidewalls is preferably 5 nm or less.

Besides those described above, the polymer constituting the fine particle 13 may be composed of a monomer polymerizable by e.g. radical polymerization or ion polymerization, and its components are not particularly limited. Furthermore, acrylic polymer fine particles having a particle diameter of several ten nm may also be used. Alternatively, the fine particle 13 is not limited to polymers, but may be made of an inorganic material. Inorganic fine particles can include those made of alumina sol, silica sol, and titanium oxide. The fine particle 13 only needs to be able to exist as a solid fine particle in the liquid resin 12.

Furthermore, the mixing ratio (wt % ratio) of the resin 12 and the fine particles 13 is not limited to that described above. The particle diameter and the mixing ratio of the fine particles 13 are suitably set so as not to prevent the light (such as ultraviolet radiation) from reaching the bottom of the imprint material 11. In the case where the fine particles 13 used have a higher volume shrinkage ratio under the ultraviolet irradiation than the resin 12, the mixing ratio of the fine particles 13 can be set to be relatively high.

Alternatively, the resin 12 may be thermosetting rather than photocurable, and cured by application of heat. In this case, the fine particle 13 used is different from the resin 12 in volume shrinkage ratio upon application of heat at the time of resin curing.

In the case of photocuring the resin 12, the pressure for pressing the template 20 against the imprint material 11 can be made lower than in the case of thermosetting. Furthermore, because the process can be performed at room temperature, the pattern is less prone to thermal stress. Furthermore, the template 20 is transmissive to ultraviolet radiation, and transparent to visible light. This facilitates aligning the template 20 with the imprint material 11 with high accuracy. For the foregoing reasons, the photocuring process is particularly suitable for pattern formation of semiconductor devices, which requires highly accurate formation of fine patterns.

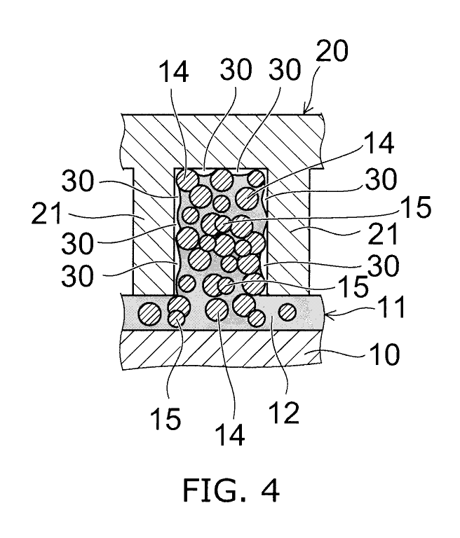

Next, FIG. 4 shows another example of the imprint material 11. FIG. 4 corresponds to FIG. 3B, and shows the state after curing the resin 12.

In the embodiment shown in FIG. 4, two types of fine particles 14, 15, in a plurality for each type, are contained in the resin 12. Both the fine particles 14, 15 have been contained in the resin 12 as solid polymers since before ultraviolet irradiation, and are present in the solid state in the resin 12 before and after the curing of the resin 12.

The fine particles 14, 15 are different from the resin 12 in volume shrinkage ratio under the ultraviolet irradiation. Furthermore, the fine particle 14 is different from the fine particle 15 in volume shrinkage ratio under the ultraviolet irradiation. For instance, the fine particle 14 has a volume shrinkage ratio of 10%, and the fine particle 15 has a volume shrinkage ratio of 30%.

Also in this embodiment, the curing shrinkage of the resin 12 is used to generate a fine gap 30 between the sidewall of the protrusion 21 of the template 20 and the imprint material 11. The solid fine particles 14, 15 contained in the resin 12 can ensure contact between the imprint material 11 and the template 20 even after the resin 12 is cured and shrunk from the liquid state. That is, the gap 30 is not widely connected along the inner wall surface of the depression 22 of the template 20, but exists in the state of being divided into a plurality by the contact portion between the template 20 and the fine particle 14, 15. This can suppress large variation in the dimension and shape of the pattern protrusion of the imprint material 11.

The imprint material 11 is in point contact with the sidewall of the protrusion 21 of the template 20 via a plurality of fine particles 14, 15. This reduces the frictional force between the sidewall of the pattern protrusion of the imprint material 11 and the sidewall of the protrusion 21 of the template 20 when the template 20 is relatively pulled up and released from the imprint material 11. Consequently, at the time of releasing, the stress acting on the imprint material 11 is reduced. This can suppress pattern defects of the pattern protrusion of the imprint material 11, such as deformation, breakage, fracture, and collapse.

Furthermore, the plurality of solid fine particles 14, 15 contained in the resin 12 increase the mechanical strength of the imprint material 11. This also serves to avoid pattern defects of the imprint material 11 at the time of releasing.

The releasability, and the pattern dimension and shape of the imprint material 11 depend on the size, number, and presence density of the gaps 30. The size, number, and presence density of the gaps 30 in turn depend on the volume shrinkage ratio of the resin 12 and the fine particles 14, 15. Hence, by mixing two types of fine particles 14, 15 having different volume shrinkage ratios in the resin 12, the number of adjustment parameters such as the size, number, and presence density of the gaps 30 increases. This facilitates characteristics control of the imprint material 11 in view of appropriate balance between the releasability and the variation in the pattern dimension and shape of the imprint material 11.

Volume shrinkage of a polymer fine particle is associated with density increase by polymerization. For instance, the polymerization can be an extension reaction of the polymer chain with a radical acting as a reaction center. In this case, by increasing or decreasing the number of polymer chains, the volume shrinkage ratio of the polymer fine particle can be freely changed. The number of types of fine particles having different volume shrinkage ratios is not limited to two, but may be three or more.

Furthermore, a plurality of fine particles having different particle diameters may be contained in the resin 12. For instance, in the embodiment shown in FIG. 4, the particle diameter of the fine particle 14 is set to 20 nm, and the particle diameter of the fine particle 15 is set to 5 nm. In this case, even if the fine particle 14 has the same volume shrinkage ratio (e.g., 30%) as the fine particle 15, the fine particle 14 having a particle diameter of 20 nm is isotropically shrunk by e.g. 6 nm upon ultraviolet irradiation, and the fine particle 15 having a particle diameter of 5 nm is isotropically shrunk by e.g. 1.5 nm upon ultraviolet irradiation. The size, number, and presence density of the gaps 30 also vary with the difference in the amount of shrinkage between the fine particles 14, 15.

Hence, by mixing a plurality of fine particles 14, 15 having different particle diameters in the resin 12, the number of adjustment parameters such as the size, number, and presence density of the gaps 30 increases. This facilitates characteristics control of the imprint material 11 in view of appropriate balance between the releasability and the variation in the pattern dimension and shape of the imprint material 11.

The embodiments are not limited to pattern formation of semiconductor devices, but also applicable to pattern formation of patterned media such as magnetic discs, and of optical components.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

1. An imprint material comprising:
a resin configured to be cured from a liquid state by receiving energy while being in contact with a protrusion-depression pattern of a template; and
a plurality of fine particles contained in a solid state in the resin and being different from the resin in volume shrinkage ratio upon receiving the energy.

2. The material according to claim 1, wherein the volume shrinkage ratio of the fine particle is lower than the volume shrinkage ratio of the resin.

3. The material according to claim 1, wherein the plurality of fine particles include ones being different in the volume shrinkage ratio.

4. The material according to claim 2, wherein the plurality of fine particles include ones being different in the volume shrinkage ratio.

5. The material according to claim 1, wherein the plurality of fine particles include ones being different in a particle diameter.

6. The material according to claim 5, wherein the fine particles different in the particle diameter are different in amount of shrinkage upon receiving the energy.

7. The material according to claim 1, wherein the fine particles are polymer fine particles.

8. The material according to claim 1, wherein the fine particles are inorganic fine particles.

9. The material according to claim 1, wherein the resin is cured by receiving light as the energy.

10. A processing method comprising:
supplying an imprint material onto a foundation layer, the imprint material including a liquid resin and a plurality of fine particles contained in a solid state in the resin and being different from the resin in volume shrinkage ratio upon receiving energy for curing the resin;
bringing a protrusion-depression pattern of a template into contact with the imprint material;
applying the energy to the liquid resin in contact with the template to cure the resin to transfer a reverse pattern of the protrusion-depression pattern of the template into the imprint material;
after curing the resin, separating the template from the imprint material; and
after separating the template from the imprint material, performing processing on the foundation layer by using the imprint material as a mask.

11. The method according to claim 10, wherein after curing the resin, contact area between a sidewall of a protrusion of the template and the fine particles is larger than contact area between the sidewall of the protrusion of the template and the resin.

12. The method according to claim 10, wherein the resin is cured by irradiation with light as the energy.
